(19) United States
(12) Patent Application Publication
(10) Pub. No.: US 2008/0205691 A1
(43) Pub. Date: Aug. 28, 2008

(54) MOVING ARMATURE RECEIVER WITH REDUCED PARASITIC COUPLING

(76) Inventors: Niels Beekman, Hilversum (NL); Dennis Jacobus Mattheus Mocking, Utrecht (NL); Peter Madaffari, Camden, ME (US)

Correspondence Address: NIXON PEABODY, LLP, 161 N. CLARK ST., 48TH FLOOR, CHICAGO, IL, 60601-3213, US

(21) Appl. No.: 12/070,486

(22) Filed: Feb. 19, 2008

Related U.S. Application Data
(60) Provisional application No. 60/902,441, filed on Feb. 20, 2007.

(51) Int. Cl. H04R 1/00

(52) U.S. Cl. 381/417

(57) ABSTRACT

A moving magnet receiver having a housing portion reducing parasitic flux between the housing and the coil. The housing has a housing portion adjacent to the coil and which has a lower magnetic permeability than a housing part position adjacent to the magnet assembly.

### CROSS-REFERENCE TO RELATED APPLICATION

This application claims the benefit of the U.S. Provisional Application 60/902,441, filed on Feb. 20, 2007, entitled “A Moving Armature Receiver” and is hereby incorporated by reference in its entirety.

### FIELD OF THE INVENTION

The present invention relates to moving armature receivers in which an armature is provided in the magnetic field of one or more coils and is vibrated due to an electrical signal being introduced into the coil. In particular, the present invention relates to compact moving armature receivers with reduced parasitic flux paths.

### BACKGROUND OF THE INVENTION

Different types of receivers may be seen in WO 2004/064483, WO 95/07014, U.S. Pat. No. 7,054,460, and US 2005/0276433. None of these, however, relate to the reduction of parasitic flux paths, such as those experienced when minimizing receivers.

### SUMMARY OF THE INVENTION

In a one aspect, a moving armature receiver comprises a housing having therein a permanent magnet assembly generating a magnetic field in an air gap, an electrically conductive drive coil comprising a coil tunnel, and a magnetically permeable diaphragm assembly extending in a first direction through the air gap and the coil tunnel. The housing comprises a first housing part positioned adjacent to the magnet assembly and having a first magnetic permeability and a second housing part positioned adjacent to the drive coil and having a second magnetic permeability being lower than the first magnetic permeability.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

In the following, certain embodiments of the invention will be described with reference to the drawings, wherein:

FIG. 1 illustrates a cross section through a receiver according to an embodiment of the disclosed receiver.

FIG. 2 illustrates a first sub-assembly for the receiver shown in FIG. 1.

FIG. 3 illustrates a second sub-assembly for the receiver shown in FIG. 1.

FIG. 4 illustrates an embodiment for providing a reduced parasitic coupling between a housing and a coil.

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated and/or described herein.

### DETAILED DESCRIPTION OF ILLUSTRATIVE EMBODIMENTS

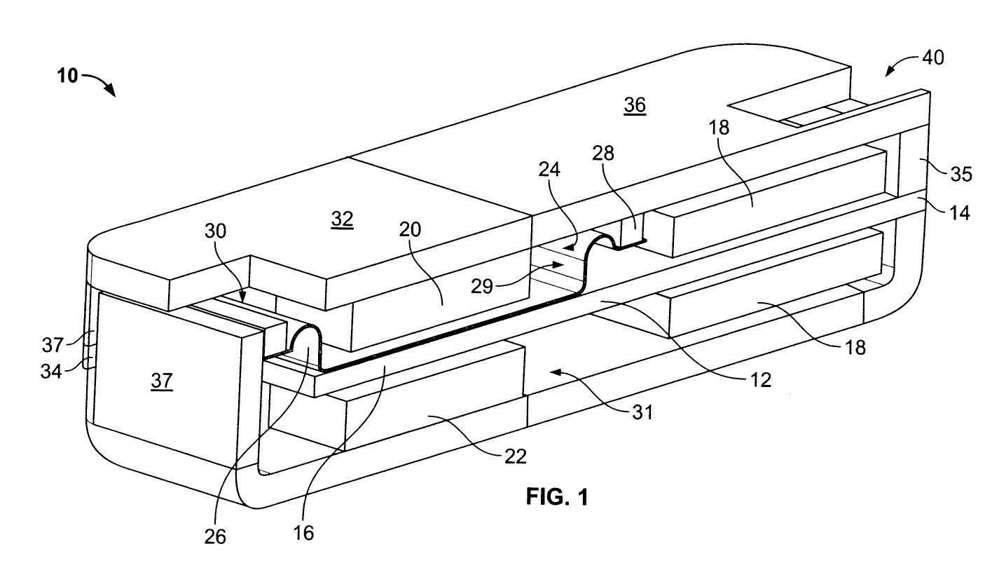

The receiver 10 of FIG. 1 has a moving armature 12 fixed at one end 14 thereof relative to a housing. The other end, 16, of the armature 12 is movable.

The armature 12 is moved by an AC flux generated by a coil 18 (due to an AC current provided therein via an opening 40) surrounding a part of the armature 12, which AC flux enters a DC flux generated by two magnets 20 and 22. Due to these fluxes, the armature 12 carrying the AC flux will move toward and away from the individual magnets 20, 22.

Attached to the armature 12 at the moving end 16 is a diaphragm 24 which together with the armature 12 forms a magnetically permeable diaphragm assembly, and which has bent or resilient side portions 26 engaging a sealing member 28 which seals a space 29 above the diaphragm 24 from a space 31 below the diaphragm 24. The spaces 29 and 31 normally are called the front chamber and the back chamber of the receiver 10 and will be referred to hereinafter as chambers for convenience.

Due to the resilient side portions 26, the diaphragm 24 may be moved up and down by the armature 12 while maintaining the sealing against the member 28 so that an acoustic sealing is maintained. As is usual in this type of receiver 10, a DC vent may exist between the chambers 29, 31.

Alternatively, the member 28 may be resilient so as to provide the deformability desired in order to maintain the sealing of the two chambers 29, 31 from each other.

Areas 32 and 34 are also provided in the housing. The operation of these parts will be described further below.

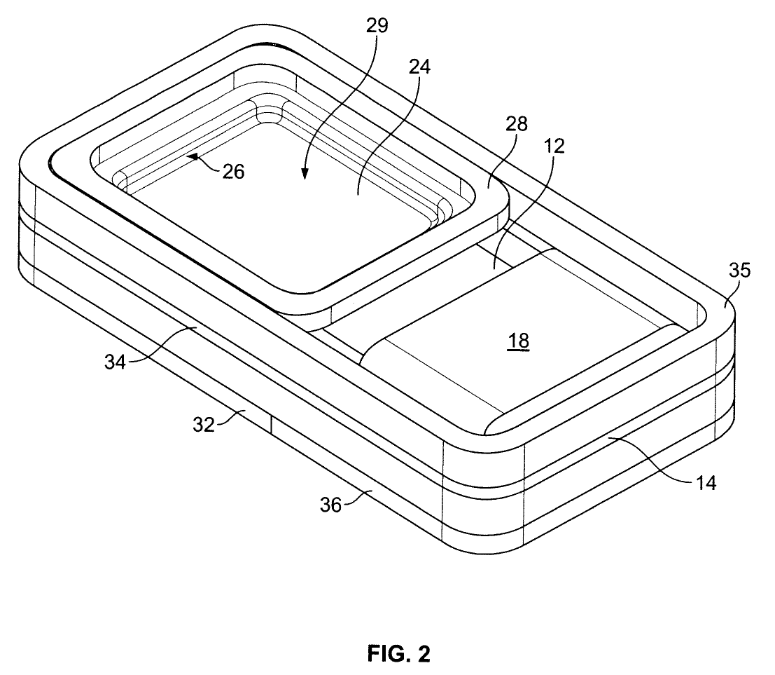

FIG. 2 illustrates a sub-assembly of the receiver 10, wherein the upper housing portions 32 and 36 are not mounted, so that the coil 18, the diaphragm 24 and the sealing member 28 are visible. It is seen that the sealing member 28 is adapted to seal both with the longitudinal inner side portions (part 37) of the receiver 10 as well as the end surface and the top portion 36 when mounted. Naturally, it is not required to seal both toward the side portions and the top portion. From FIG. 1, it is seen that the sound output 30 extends sufficiently far from the output end to provide an opening into the chamber 29 defined by the upper side of the diaphragm 24.

The sound pressure generated by the moving diaphragm 24 is output from the housing via the sound output 30 provided therein.

In order for the receiver to function optimally, it is desired that, for example, the DC flux generated by the permanent magnets 20, 22 is as strong as possible in the air gap there between whereby it is desired that a magnetically permeable flux return path between the permanent magnets 20, 22 outside the air gap is provided. Thus, it is desired that the housing portions 32, to which the permanent magnets 20, 22 are attached, are magnetically permeable or conductive, and that housing portions interconnecting these, such as housing portions 34 (positioned symmetrically in the receiver 10), described further below, also are magnetically permeable.

In this manner, the flux path from the air gap is through one of the permanent magnets 20, 22, the upper housing portion 32, the housing portion 34, the lower housing portion 32, the other one of the permanent magnets 20, 22, and to the air gap. This flux path is normally denoted the DC flux path in that it is generated by permanent magnets 20, 22.

It is seen that the DC flux path extends through the diaphragm 24 and the armature 12 where it interacts with a flux path, normally denoted the AC flux path, generated by the coil 18. The AC flux path also is a closed flux path extending in the armature 12 and diaphragm 24 and exits these elements to enter the magnetically permeable housing portion 34 extending the full length of the receiver 10 and in parallel to the armature 12 and diaphragm 24.

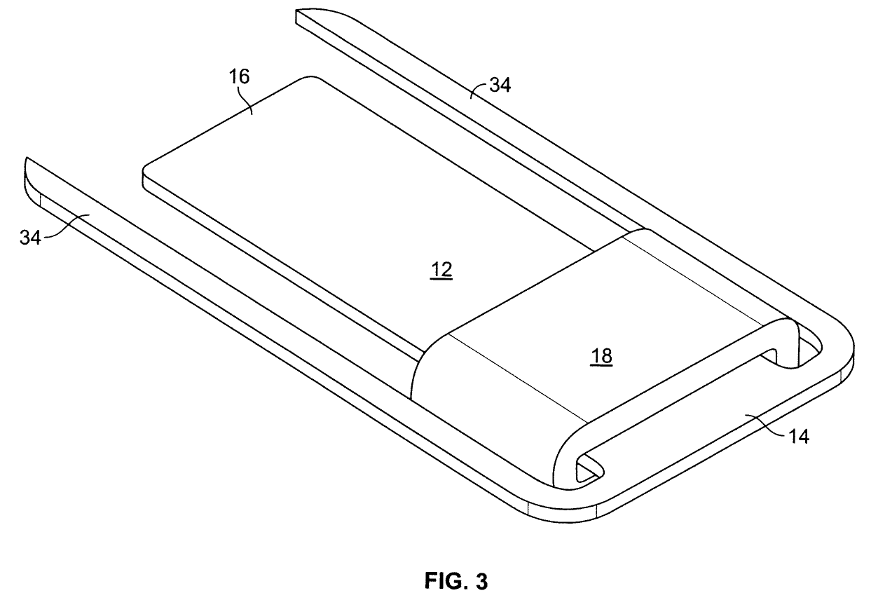

FIG. 3 illustrates a sub-assembly of the receiver 10 wherein it is seen that the armature 12 may be made of the same piece of material as the housing portions 34, whereby the optimal magnetic connection/conduction is provided between these parts. This also reduces the parasitic coupling in that the magnetic permeability between these parts is optimized.

Especially when desiring to provide miniaturized receivers, parasitic losses will occur due to flux paths occurring which remove flux from the positions, such as the air gap, where it is desired. Such parasitic paths reduce the efficiency of the receiver 10.

In the present type of receiver 10, a parasitic flux path is seen between the permanent magnets 20, 22 via the housing to the coil 18. Such a flux path will have flux from the magnet 20 travelling not inside the air gap to the magnet 22, but to the armature 12/diaphragm 24 to the coil 18 and back to the magnet via the housing.

Another parasitic flux path may be that from inside the coil 18 via the armature 12, the housing portion 36 (if it was magnetically permeable; see below) and back into the coil 18.

In order to remove these flux paths, the upper housing portion 36 is made of a magnetically non-permeable or non-conducting material. In this manner, the only flux path from the permanent magnets 20, 22 to the coil 18 is via the magnetically permeable housing portion(s) 34 extending along the length of the receiver 10. However, this parasitic flux path is quite small in that the dimensional overlap between the housing portion(s) 34 and the coil 18 is vastly reduced compared to the overlap between the housing portions 36 and the coil 18. In addition, AC flux from the coil 18 must then travel via the armature 12, the upper housing portion(s) 34 and back to the fixed end 14 of the armature.

In order to further increase the active flux paths, the housing portion(s) 32 preferably extend(s) only, in the direction toward the end 14, to the end portion of the permanent magnets 20, 22. Also, it is desired that the armature 12 is not wider than the extent of the permanent magnets 20, 22 in the direction perpendicular to the longitudinal axis of the receiver 10 in order to reduce any flux travelling from the armature 12 to the housing portions 32 but outside the permanent magnets 20, 22.

In the AC flux path, the flux from the armature 12/diaphragm 24 will travel from the edges thereof and to the upper housing portion 34 or the end element 37 of the receiver 10 and thereby back to the far end part 35 of the receiver in order to enter the fixed end 14 of the armature and close the flux path. Flux may also flow from the armature 12 through the diaphragm 24 and the elements 28 to the end element 37 or upper housing portion 34. This flux path is equally useful.

The AC flux path generally lies in a plane parallel to that of the diaphragm 24, whereas the DC flux path generally lies in a plane perpendicular to the plane of the diaphragm 24.

Thus, both flux paths are closed and optimized and will ensure that as much of the flux as possible is brought to the positions where it is desired, while parasitic flux paths are reduced and removed.

In a presently preferred embodiment, the diaphragm 24 is made of a 2 μm thick sheet of PET which may be coated by a magnetically permeable material, such as Ni. In addition, the armature 12 may be 0.1 mm thick and the part 37 may be 0.32 mm thick, and both may be made of 50% Fe and 50% Ni, as may the housing parts and the part 37. The parts 34 and 37, as well as the sealing member 28, may be made of brass (63% Cu and 37% Zn).

The magnets may be AlNiCo magnets with a thickness of 0.25 mm, and the coil 18 may have 550 windings of a 20 μm self-bonding wire.

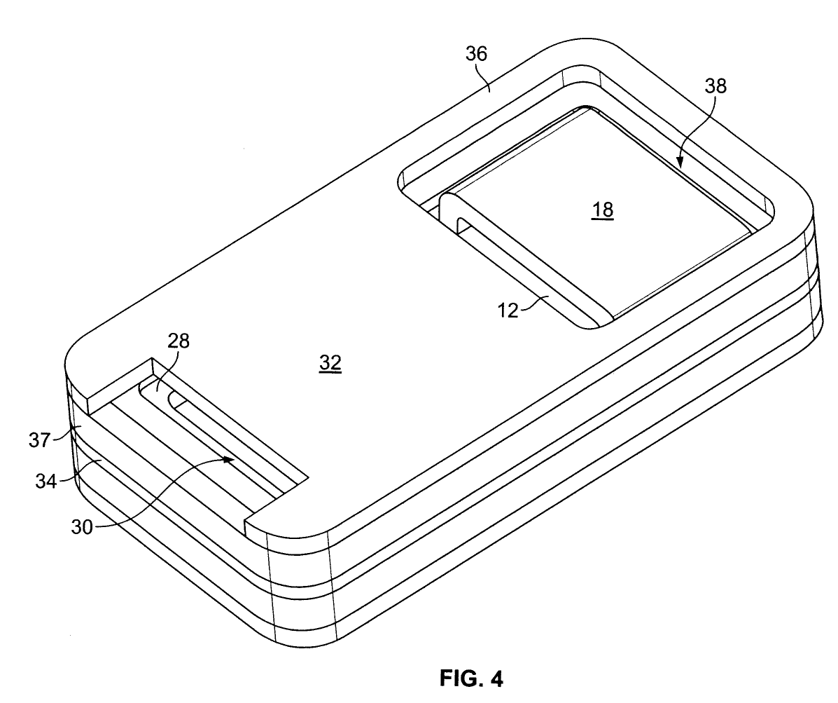

FIG. 4 illustrates an alternative manner of reducing the parasitic flux path between the coil 18 and the housing in that the housing portions 32, 36 now are made of a single piece of material, but where an opening 38 is provided in the housing portion 36. The opening 38 may be filled with a material with a lower magnetic permeability, or it may be open. In the latter situation, it may be desired to provide an outer housing or the like (such as a rubber tube or sock normally used for holding and shielding receivers in hearing aids) in order to prevent sound output from the opening 38 to mix with sound output from the sound output 30.

An alternative to the opening 38 may be the providing of a number of openings in the housing portion 36. Again, these openings may or may not be filled with a material having a lower magnetic permeability. Also, instead of openings, a reduced thickness of the material of the housing portion 36 may be used for reducing the parasitic coupling between the coil 18 and that part of the housing. If the thickness is reduced to a degree where the stability or strength of the housing is unsuitable, the housing may at that position be reinforced using a material of a lower magnetic permeability, such as providing the lower permeability material in any indentations made in the housing material.

An alternative to the providing of the opening(s) or reduced thickness portion(s) directly adjacent (such as above) the coil 18, these may be provided evenly distributed over the full area of the housing portion 36 or may be provided at a peripheral part thereof, where a central portion thereof may then have any desired magnetic permeability in that this area is “magnetically isolated” from, for example, the housing portion 32 by these peripheral parts.

Naturally, the attached diaphragm 24 and armature 12 may be replaced by a single element which has the width desired of the diaphragm in order to generate the desired sound pressure and in order to enable sealing the front chamber from the back chamber. This sealing may be provided in the same manner as illustrated in FIG. 2 or may be provided at the sides of the diaphragm/armature and to the inner surfaces of the receiver housing. In this situation, the material of the armature/diaphragm normally will be relatively stiff, whereby the resiliency desired to take up the movement thereof may be provided by the sealing material.

In order to obtain a balanced setup, the two permanent magnets 20, 22 have been provided on either side of the diaphragm assembly. One of these permanent magnets 20, 22 may, however, be replaced or removed in order to utilize only a single magnet (that is, one of 20, 22) for generating the DC flux.

It is seen that the present receiver 10 may be made extremely small while maintaining the useful flux paths and reducing or suppressing the parasitic flux paths. In fact, the thickness of the receiver 10 is determined by the thickness of the housing parts 32, the magnets 20, 22 as well as the size of the air gap there between. In addition, a flat, wide coil 18 may be used which may be used inside this thin housing.

The present receiver 10 may be as thin as 1 mm or thinner, and the width thereof may be 2.7 mm or narrower.

In the present context, “adjacent to” means that the first housing part is closer to the magnet assembly than the second housing part, and that the second housing part is closer to the coil than the first housing part. In fact, the first and second housing parts may form parts of the housing which, when the housing parts, the drive coil and the magnet assembly are projected to a predetermined plane, overlap the magnet assembly and the drive coil, respectively. Also, in certain embodiments, the first and second housing parts do not overlap.

In the present context, a magnet assembly may comprise one or more magnets positioned together or at different positions in the receiver while all participating in generating the magnetic field provided in the air gap.

The coil may comprise one or more coils defining the coil tunnel.

The diaphragm assembly may comprise one or more parts, one or more of which may be magnetically permeable. In certain embodiments, a part thereof extending through both the air gap and the coil tunnel is magnetically permeable in order to conduct the magnetic field from the coil tunnel to the air gap.

In this context, prior art receivers have a parasitic coupling between the coil and the housing. The whole housing normally is magnetically permeable, made of the same material, and positioned quite closely to the coil in order to not waste space in the receiver. Normally, the housing has the same cross section along its length (along the direction of the armature). This parasitic coupling is reduced according to the present disclosure by providing a housing part adjacent to the drive coil and having a magnetic permeability lower than that of material positioned adjacent to the magnetic assembly.

This reduction may be obtained in a number of manners. One manner is one wherein the second housing part comprises one or more openings or holes. In this situation, the first and second housing parts may be made of the same material. The holes or openings will then provide a lower overall magnetic permeability compared to that of the actual material. In order to prevent sound from exiting such holes, alternatively, these holes/openings may be filled with a material of a low (lower than the material of the first housing part or the material of the second housing part having the holes/openings) magnetic permeability.

Another manner is to provide a second housing part with one or more areas of reduced thickness. If these areas then generate an unsuitably low strength, for example, of the housing, these areas of reduced thickness may be “filled with” or otherwise provided with a material with a lower magnetic permeability in order to increase the strength while maintaining the overall magnetic permeability of the second housing part sufficiently low.

The areas of reduced thickness or the areas in which the holes/openings are provided may be chosen in a number of manners. In one manner, the openings/holes/areas are distributed evenly over the second housing part. In another manner, they are provided in a peripheral area of the second housing part so that the central part thereof, and even the part being the closest to the drive coil, may have a magnetic permeability as high as that of the first housing part, but this part is surrounded by lower-permeability parts, which magnetically “isolates” the central part and therefore prevents or reduces the parasitic coupling to the coil.

Yet another manner of providing the second housing part is to simply provide the whole part of a material having a lower magnetic permeability than the material of the first housing part (or the mean permeability of the first housing part if this is made of different materials or of a material of abnormal dimensions). Thus, the second housing part may be made of a material different from that of the first housing part.

Thus, the second housing part may be made of a diamagnetic or non-magnetic paramagnetic material or may be made of a magnetically permeable material but which is provided with reduced with holes/openings/narrowings, such as filled with a diamagnetic or non-magnetic material, so that the effective magnetic permeability is reduced.

In a certain embodiment, the first housing part forms part of a first closed magnetic flux path comprising the first housing part, the permanent magnet assembly, the air gap, and the magnetically permeable diaphragm assembly. This flux path, normally called the DC flux path, then has an optimized magnetic permeability providing optimal function of the receiver.

In this context, a flux path is the path which the flux of a magnet (or a stack of magnets) takes from one pole of a magnet to the other pole of that magnet. Naturally, more magnets may be part of a flux path, where flux runs from one pole of one magnet to a pole of the other magnet, etc. All flux paths are closed in that flux lines cannot be open. Flux runs through all materials, if need be, but as electrical signals, good conductors are preferred/used, if such are present and available.

Also, in this embodiment, the first housing part can comprise—or can be made of—a material with a relative permeability greater than 250, such as greater than 5,000, such as a ferromagnetic material or soft magnetic material. If the first housing part is a composite element, the overall permeability can fulfil these requirements.

In addition, in a certain embodiment, the second housing part, which has a reduced magnetic permeability or which is non-magnetically permeable, can comprise a material with a relative permeability smaller than 2, such as a material selected from the group consisting of a diamagnetic material and a non-magnetic material. Alternatively, this housing part can be made of a composite material comprising both a material with a higher magnetic permeability and one or more materials which are not magnetically permeable, where the housing part then has the desired overall (such as mean) magnetic permeability.

Furthermore, in this embodiment, the drive coil can have a flat cross-section with a predetermined width and height.

In general, the housing can have, perpendicularly to the first direction, a D-shaped or a rectangularly shaped cross-section having at least one at least substantially flat part arranged substantially parallel to a plane of the diaphragm assembly. In this situation, the first and second housing parts can form at least part of the at least substantially flat part(s). Due to the flat part having the largest surface portion exposed to the coil, providing the second housing part in this position, the largest reduction is seen in the parasitic flux path.

Also, the housing can comprise a third, magnetically permeable housing part extending in the first direction and forming part of a closed AC magnetic flux path extending through the magnetically permeable diaphragm assembly. This AC flux path is that generated by the coil and which is to be transported to the air gap in order to obtain movement of the diaphragm assembly. In order to optimize this flux path, the third housing part is provided which conducts or guides the flux at least part of the way back from the air gap to the coil.

In this situation, the diaphragm assembly can have a flat cross-section in a plane perpendicular to the first direction, and the third housing part extends at least substantially in a plane of the diaphragm assembly. Thus, as the magnets are normally positioned over or under the diaphragm assembly, the diaphragm assembly is directly exposed to the third housing part in this plane or direction, which then provides the best transfer of flux there between. In addition, and especially if the receiver is flat, the exposure of the third housing part to the coil is reduced, at least compared to the above flat surface, whereby the parasitic flux path between the housing and coil is reduced, compared to the situation where it is defined by all of the housing from the air gap end to the coil end, but however present. This cannot be avoided in that the AC flux path must exist.

It is seen that the AC flux path then generally travels in the plane of the diaphragm assembly.

In general, receivers incorporating the present disclosure can be made quite small. Thus, the housing can have a largest dimension, perpendicular to a plane defined by the diaphragm assembly, of no more than 1.9 mm, such as no more than 1.5 mm. In certain embodiments, the largest dimension can be no greater than 1 mm, such as no more than 0.8 mm.

In addition, the housing can, in a plane perpendicular to the first direction, have a width in a plane defined by the diaphragm assembly and a thickness perpendicular thereto, the width being between 1 and 10 times the thickness, such as between 1 and 5 times the thickness or between 2.4 and 4 times the thickness.

Each of these embodiments and obvious variations thereof is contemplated as falling within the spirit and scope of the claimed invention, which is set forth in the following claims.

What is claimed is:

1. A moving armature receiver comprising a housing having therein:
a permanent magnet assembly generating a magnetic field in an air gap,
an electrically conductive drive coil comprising a coil tunnel,
and
a magnetically permeable diaphragm assembly extending in a first direction through the air gap and the coil tunnel,
wherein the housing comprises a first housing part positioned adjacent to the magnet assembly and having a first magnetic permeability and a second housing part positioned adjacent to the drive coil and having a second magnetic permeability being lower than the first magnetic permeability.

2. A receiver according to claim 1, wherein the second housing part comprises one or more openings or holes.

3. A receiver according to claim 2, wherein the openings or holes of the second housing part are filled with a material of a low magnetic permeability.

4. A receiver according to claim 1, wherein the second housing part has one or more areas of reduced thickness.

5. A receiver according to claim 4, wherein one or more of the areas of reduced thickness comprise a material of a low magnetic permeability.

6. A receiver according to claim 1, wherein the housing comprises a third magnetically permeable housing part extending in the first direction and forming part of a closed AC magnetic flux path extending through the diaphragm assembly.

7. A receiver according to claim 1, wherein the first housing part forms part of a first closed magnetic flux path comprising the first magnetically permeable housing part, the permanent magnet assembly, the air gap, and the diaphragm assembly.

8. A receiver according to claim 1, wherein the housing has a largest dimension, perpendicular to a plane defined by the diaphragm assembly, of no more than 1.9 mm.

9. A receiver according to claim 1, wherein the housing, in a plane perpendicular to the first direction, has a width in a plane defined by the diaphragm assembly and a thickness perpendicular thereto, the width being between 1 and 10 times the thickness.

10. A receiver according to claim 1, wherein the drive coil has a flat cross-section with a predetermined width and height and the second housing part is shaped to reduce parasitic inductive coupling between the drive coil and the receiver housing.
